(19) United States
(12) Patent Application Publication
(10) Pub. No.: US 2012/0179351 A1
(43) Pub. Date: Jul. 12, 2012

(54) METHOD FOR CONTROLLING AN ADAPTIVE CRUISE CONTROL SYSTEM AND ASSOCIATED CONTROL SYSTEM

(75) Inventor: Mickael Mallet, Montigny Le Bretonneux (FR)

(73) Assignee: RENAULT S.A.S., Boulogne Billancourt (FR)

(21) Appl. No.: 13/382,739

(22) PCT Filed: Apr. 6, 2010
(86) PCT No.: PCT/FR2010/050656

§ 371 Date: Mar. 23, 2012

(30) Foreign Application Priority Data
Jul. 8, 2009 (FR) 0954705

(51) Int. Cl. B60K 31/00

(52) U.S. Cl. 701/96

(57) ABSTRACT

A control of a motor vehicle adaptive cruise control system in which a computer of the control system receives a set point speed value and information relating to the speed unit from an instrument panel computer via a CAN bus. The information relating to the speed unit received at the moment of activation of the cruise control system is stored in memory, and throughout the time for which the cruise control system is activated, any change in the information relating to the speed unit received by comparison with the information stored in memory is monitored. If need be, an information item relating to a speed unit fault is generated.

The present invention relates to speed regulating systems with distance control, or ACC systems (the initials standing for “Adaptive Cruise Control”), fitted to certain motor vehicles.

An ACC system allows, on the one hand, the driver of the motor vehicle to select a cruising speed at which the vehicle will travel without the driver having to keep his foot on the accelerator and, on the other hand, the vehicle to automatically maintain a safety distance from a vehicle in front of the vehicle of the driver, on the basis of the detection of the environment present ahead of the vehicle.

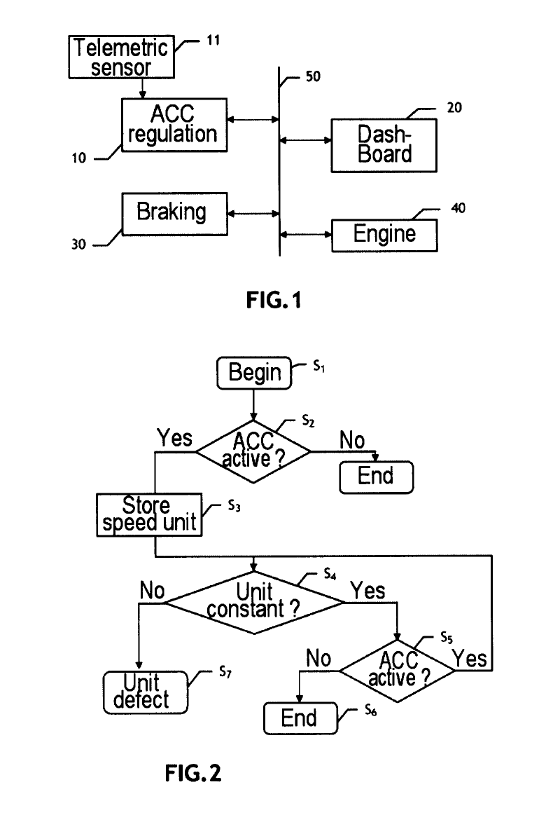

Accordingly, and as represented schematically in FIG. 1, an ACC system conventionally comprises a regulating computer 10 linked to the other computers (dashboard controller 20, controller of the braking system 30 and controller of the engine 40) fitted to the motor vehicle by a CAN bus 50 (the initials standing for “Controller Area Network”), as well as a telemetric sensor 11, for example of the LIDAR (LIght Detection And Ranging) or RADAR type, able to transmit a signal on the basis of which the regulating computer is capable of detecting the presence of a vehicle, or of an obstacle, on the road scene situated ahead of the vehicle. The role of the ACC system being to adapt the speed of the vehicle as a function of the distance separating this vehicle from the one in front of it, the ACC system automatically commands an automatic deceleration of the vehicle if the safety distance is exceeded, and then an automatic acceleration up to the cruising speed if the route clears.

For all that, the purpose of the ACC system is not to substitute itself for the driver, the latter having always to be able to resume control of the speed of his vehicle. Thus, the automatic deceleration commanded by the ACC system is fairly mild, and the driver must be able to intervene rapidly if the situation so demands. The ACC system is consequently adapted to be able to transfer alert requests to the controller of the dashboard 20, via the CAN bus 50, the controller of the dashboard 20 then commanding the emission of sound and/or visual signals signifying to the driver that he is in a situation requiring particular vigilance.

It is understood that such a system, the aim of which is to ensure driving comfort, must be supplemented with measures making it possible to guarantee safety.

Certain measures are related to the system activation conditions. Thus, the system must be activated only on an intentional action of the driver. Moreover, the ACC system cannot generally be activated if the vehicle is traveling below a certain speed, typically of the order of 30 km/h. Furthermore, provision may be made to prohibit the activation of the ACC system when the presence of rain is detected.

Other measures relate to the conditions of deactivation of the ACC system. Thus, the ACC system deactivates as soon as the driver presses on the brake pedal. Moreover, the settings of the ACC system are suspended as long as the driver presses on the accelerator pedal. In certain cases, the ACC system can also be deactivated subsequent to the detection of the enabling of the windshield wiper system.

However, it remains necessary to guarantee the system against the occurrence of events which are independent of the will of the driver or environmental conditions such as the climatic conditions or the detection of the presence of a vehicle in front.

In particular, as the ACC system performs regulation on the basis of the knowledge of a cruising speed chosen by the driver, it is important to be certain of the reliability of any information item relating to this cruising speed.

Today, the driver selects the cruising speed on the basis of the speed information item which is displayed on the dashboard. Once selected, the computer 20 of the dashboard transmits the corresponding speed setting to the ACC regulating computer 10, via the CAN bus 50.

Furthermore, for certain dashboards provision is made for a possibility of toggling between speeds displayed in km/hour or speeds displayed in miles/hour. In this case, the computer 20 of the dashboard must transmit not only the speed setting but also the speed unit in which the dashboard has been configured, to the ACC regulating computer 10.

The configuration of the dashboard by the driver can only be performed when the vehicle is stationary. Thus, when the ACC system is activated, the speed unit which is transmitted to it corresponds theoretically to that which has been configured.

In practice, however, there exists a risk of corruption of the unit value transmitted by the dashboard. More precisely, an untimely switching in the speed unit while the ACC system is activated may cause an untimely acceleration or deceleration, depending on the direction of switching.

This results in an inadequacy in terms of operating dependability.

The aim of the present invention is to alleviate this inadequacy.

Thus, the subject of the present invention is a method for controlling a speed regulating system with distance control for motor vehicle, in which a computer of said regulating system receives a speed setting value and an information item relating to the speed unit of a dashboard computer by way of a CAN bus, characterized in that it consists in storing the information item relating to the speed unit received at the moment of the activation of the regulating system, in monitoring, throughout the duration of activation of the regulating system, any change of the information item relating to the speed unit received with respect to the information item stored, and in generating if appropriate an information item relating to the speed unit defect.

The subject of the present invention is also a speed regulating system with distance control for motor vehicle, comprising a computer able to receive a speed setting value and an information item relating to the speed unit of a dashboard computer by way of a CAN bus, characterized in that it is able to store the information item relating to the speed unit received at the moment of the activation of the regulating system, to monitor, throughout the duration of activation of the regulating system, any change of the information item relating to the speed unit received with respect to the information item stored, and to generate if appropriate an information item relating to the speed unit defect.

The invention will be better understood in view of the following description given with reference to the appended figures, in which:

FIG. 1, already described, schematically illustrates the connection of various computers fitted to a motor vehicle, including the ACC regulating computer and the computer of the dashboard, by means of a CAN bus;

FIG. 2 describes, in overview form, the various steps preferably implemented in the method according to the invention.

The initial condition S₁ of a vehicle whose ACC system is liable to be activated is considered with reference to FIG. 2. The control in accordance with the invention being of interest only when the ACC system has actually been activated, it is verified beforehand that this condition is fulfilled (step S₂). If appropriate, the regulating computer 10 therefore receives the information regarding speed setting selected by the driver and speed unit emitted by computer 20 of the dashboard. In accordance with the invention, the information item relating to the speed unit is stored (step S₃). Steps S₄ to S₅ serve to verify whether the speed unit transmitted by the computer 20 of the dashboard remains properly constant throughout the duration of activation of the ACC system, stated otherwise, whether it is always equal to the speed unit stored in step S₃. In the converse case, an information item relating to the unit defect is generated by the regulating computer 10 (step S₇). Monitoring is halted as soon as the ACC system is deactivated, whatever the reason for this deactivation (step S₆).

By virtue of this monitoring, the regulating computer 10 can decide on certain actions making it possible to guarantee safety. In the preferred embodiment, the ACC system is deactivated as soon as an information item relating to the unit defect has been generated.

1-4. (canceled)

5. A method for controlling a speed regulating system with distance control for a motor vehicle, comprising:
a computer of the regulating system receiving a speed setting value and an information item relating to a speed unit of a dashboard computer by a CAN bus;
storing the information item relating to the speed unit received at a moment of activation of the regulating system;
monitoring, throughout duration of activation of the regulating system, any change of the information item relating to the speed unit received with respect to the information item stored; and
generating if appropriate an information item relating to a defect of the speed unit.

6. The method of control as claimed in claim 5, further comprising deactivating the regulating system as soon as an information item relating to the speed unit defect has been generated.

7. A speed regulating system with distance control for a motor vehicle, comprising:
a computer configured to receive a speed setting value and an information item relating to a speed unit of a dashboard computer by a CAN bus;
the computer further configured to store the information item relating to the speed unit received at a moment of activation of the regulating system, to monitor, throughout duration of activation of the regulating system, any change of the information item relating to the speed unit received with respect to the information item stored, and to generate if appropriate an information item relating to a defect of the speed unit.

8. The regulating system as claimed in claim 7, the computer further configured to deactivate the system as soon as an information item relating to the speed unit defect has been generated.
